(19) United States
(12) Patent Application Publication
(10) Pub. No.: US 2006/0123090 A1
(43) Pub. Date: Jun. 8, 2006

(54) System and method for automatically checking an electronic document for at least one attachment

(76) Inventor: Joel Darrell Youngs, Aptos, CA (US)

Correspondence Address: Joel Darrell Youngs, 107 San Benito Ave., Aptos, CA, 95003, US

(21) Appl. No.: 11/007,824

(22) Filed: Dec. 8, 2004

(51) Int. Cl. G06F 15/16

(52) U.S. Cl. 709/206

(57) ABSTRACT

Embodiments of the invention provide a system and method for automatically checking an electronic document for at least one attachment. In one embodiment, a search protocol is provided for automatically searching an electronic document for at least one attachment term. Furthermore, an attachment protocol is provided. The attachment protocol is configured to automatically check for at least one attachment coupled with the electronic document. In addition, a comparator protocol is also provided. The comparator protocol configured to automatically compare the results of the search protocol and the attachment protocol wherein if the search protocol finds the at least one attachment term and the attachment protocol does not find the at least one attachment, the comparator protocol providing a warning prior to allowing the electronic document to be sent.

### TECHNICAL FIELD

The present invention relates to the field of electronic documents, and more particularly to an apparatus and method for automatically checking an electronic document for at least one attachment

### BACKGROUND ART

In today's connected environment, many electronic documents are passed between users. In some cases, the electronic documents are passed within a local area network (LAN) such as interoffice memos and the like. In other cases, the electronic documents are passed across a wide area network (WAN). In yet other cases, the electronic documents are passed over the Internet.

Because a plurality of providers and applications are available to utilize the network environment, in many networked situations, the number of e-mails (a general term for electronic mail) sent and received by a given person can range from 1-2 a day to numbers significantly larger. Moreover, due to the utilization of networks, the ability for users to telecommute e.g., work from locations other than on-site, is also on the rise. In addition, with the growth of wireless networks, utilizing a network from the road, hotel, coffee house, or the like is also on the rise. In each case, the utilization of e-mail (or its equivalent) is a convenient (and often necessary) way to keep in contact.

In other cases, e-mail is used between persons in the same office, household, neighborhood, and the like to transfer electronic information to one another or between the same users plurality of computing devices. For example, an employee may e-mail another employee (or boss, etc) that is only a few feet away, or across the country. In addition, a user may e-mail a photo from his/her first computing device (e.g., a mobile phone, personal digital assistant (PDA), laptop, desktop, or the like) to a second of his/her computing devices (e.g., a mobile phone, personal digital assistant (PDA), laptop, desktop, or the like).

In some cases, the e-mail is professional and in other cases it is personal. However, in either case, once the electronic document is selected to be sent, it is quickly on its way. That is, there is no time to race to the mailbox and grab the letter back from the mail carrier. Therefore, it is important that when the document is selected to be sent it is in good form. In order to ensure that the document is in good form, there is normally the option of spell checking the document before it is sent. In some cases, the user can set up the spell checking to begin working after the document is selected to be sent but before it is actually on its way.

However, a second and more significant problem with electronic mail is the sending of a document that should have an attachment but the attachment is forgotten. For example, an employee sends the boss an electronic document including a spreadsheet requested by the boss. However, after the document is sent, the employee realizes the attached document was not attached. Now the employee is in the unprofessional and uncomfortable position of resending the document with the attachment. This situation is even more deleterious when applying for a job and forgetting to attach a resume, bidding on a job and forgetting to attach the bid, as well as in a myriad of other professional or personal situations.

### DISCLOSURE OF THE INVENTION

Embodiments of the invention provide a system and method for automatically checking an electronic document for at least one attachment. In one embodiment, a search protocol is provided for automatically searching an electronic document for at least one attachment term. Furthermore, an attachment protocol is provided. The attachment protocol is configured to automatically check for at least one attachment coupled with the electronic document. In addition, a comparator protocol is also provided. The comparator protocol configured to automatically compare the results of the search protocol and the attachment protocol wherein if the search protocol finds the at least one attachment term and the attachment protocol does not find the at least one attachment, the comparator protocol providing a warning prior to allowing the electronic document to be sent.

### BRIEF DESCRIPTION OF THE DRAWINGS

The accompanying drawings, which are incorporated in and form a part of this application, illustrate embodiments of the present invention, and together with the description, serve to explain the principles of the invention. Unless noted, the drawings referred to this description should be understood as not being drawn to scale.

FIG. 1 is a diagram of an exemplary electronic document having a coupled attachment shown in accordance with one embodiment of the present invention.

FIG. 2 is an exemplary electronic document having an attachment within the document in accordance with one embodiment of the present invention.

FIG. 3 is an exemplary electronic document having no attachment in accordance with one embodiment of the present invention.

FIG. 4 is an exemplary warning screen shown in accordance with one embodiment of the present invention.

FIG. 5 is a flow chart of the steps for automatically checking an electronic document for at least one attachment prior to sending the electronic document in accordance with one embodiment of the present invention.

FIG. 6 is a block diagram of an automatic electronic document checker in accordance with one embodiment of the present invention.

FIG. 7 is a block diagram of an exemplary computer system used in accordance with one embodiment of the present invention.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

In general, the present invention provides a method and apparatus for automatically checking that an electronic document sent over a connection (e.g., a LAN, WAN, the Internet, an Ethernet, or the like) that has a reference to an attachment actually has an attachment therewith. By checking the electronic document for an attachment term and an attachment prior to sending, a verification protocol can provide an automatic warning to a user. For example, if the user has selected to send the electronic message with reference to an attachment while the document actually does not have an attachment therewith.

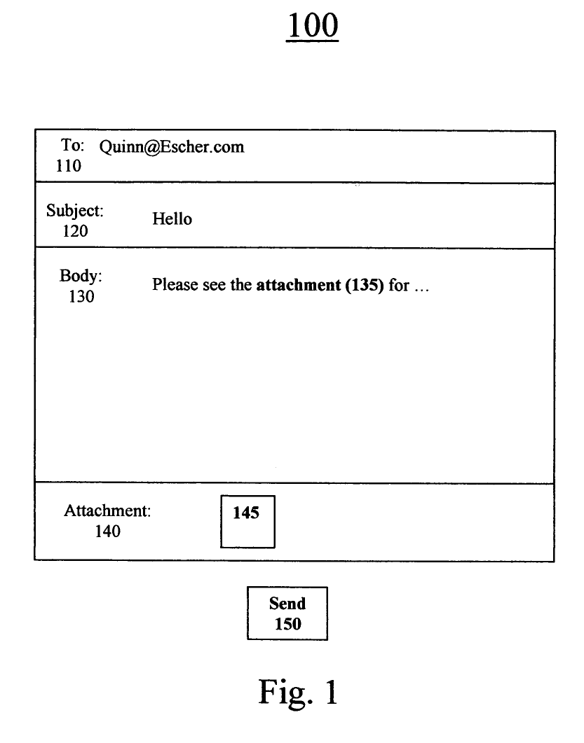

With reference now to FIG. 1, a diagram of an exemplary electronic document 100 having an attachment coupled therewith is shown in accordance with one embodiment of the present invention. Electronic document 100 includes to address 110, subject line 120, body 130, attachment section 140, and send button 150. In general, the to address 110 provides the electronic address to which the document will be sent (e.g., the e-mail address). The subject line 120 is an introductory clause. The body 130 is the portion of the electronic document 110 that will have the main body of writing therein. The attachment section 140 is a portion of the electronic document for representing any files (e.g., attachments such as documents, pictures, presentations, audio files, video files, links or the like) attached to the document. The send button 150 is the button that provides the initiation of the delivery of the electronic document 100 to the addressee 110.

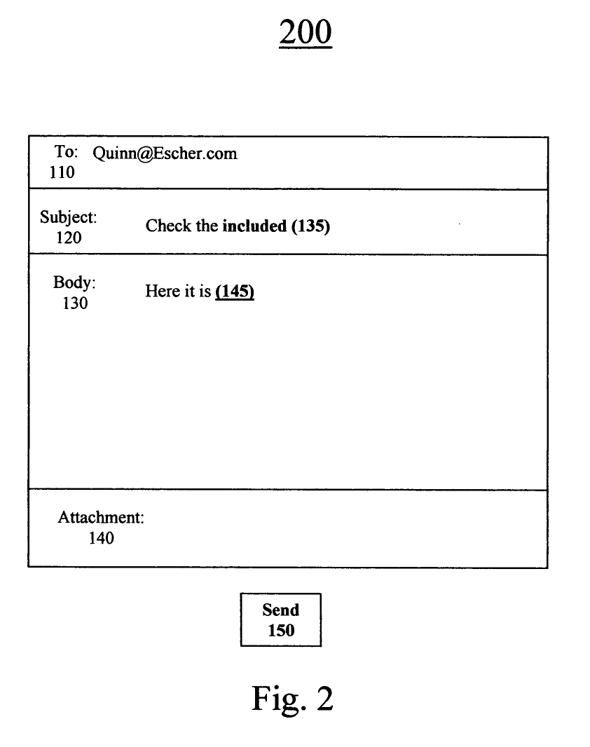

Although a plurality of formats for the electronic document are shown in FIGS. 1-3, in other embodiments the electronic document 100 (and 200 and 300) may be laid out in a variety of different formats. That is, the present invention may be utilized on a document having a different layout as well as more or fewer sections within the document. For example, in one embodiment, the electronic document will couple the attachment directly into the body (as shown in FIG. 2). Therefore, the electronic document 200 would not require the attachment section 140. The same modifications could easily result in no subject line 120, or the addition of a CC line, BCC line, or the like.

In general, the electronic document 100 may be any type of electronic document and may be sent over a plurality of connections (e.g., wireless, wired, network, dial-up, cable, Ethernet, and the like). In one embodiment, the electronic document is an e-mail.

With reference now to FIG. 2, an exemplary electronic document having an attachment 235 within the body 130 of the document is shown in accordance with an embodiment of the present invention. That is, in document 200, the attachment term is within the subject portion 120 while the attachment is within the body portion 130 of the document 200. In one embodiment, the attachment 235 is an electronic link (e.g., a HTML tag). In another embodiment, the attachment 235 is extensible mark up language (XML tag). In yet another embodiment, the attachment 235 (e.g., attachments such as documents, pictures, presentations, audio files, video files, links or the like) is placed within the body 130 of the document instead of being placed in a secondary location (e.g., attachment 140) within the document 200.

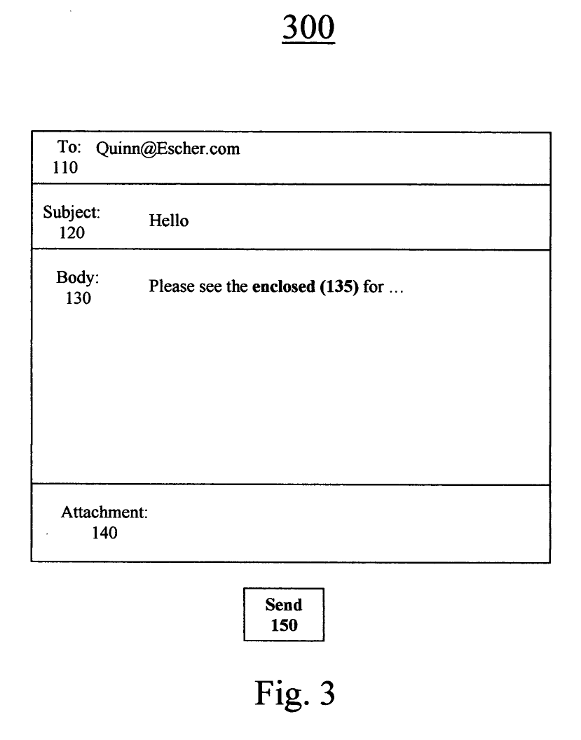

With reference now to FIG. 3, an exemplary electronic document having no attachment coupled with the document is shown in accordance with an embodiment of the present invention. That is, in document 300, the attachment term 135 is within the body 130 of the document. However, there is no attachment with the electronic document.

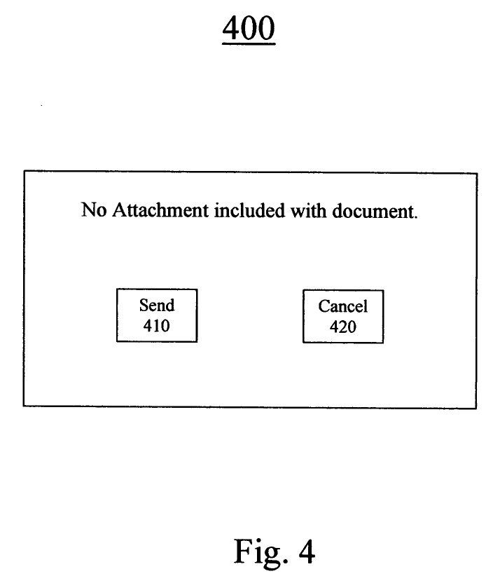

With reference now to FIG. 4, an exemplary warning screen is shown in accordance with one embodiment of the present invention. That is, FIG. 4 is one of a plurality of possible pop-up windows which may be formed utilizing HTML, XML, C, C++, DOS, or any other computing language. In general, window 400 utilizes language such as uno attachment included with the document” to provide a warning and stop option for an electronic document being sent with an attachment term but having no attachment therewith. It is noted that the vocabulary used as the warning may be different or even in a different language. The utilization of the warning language for window 400 is merely for purposes of clarity. Moreover, in another embodiment, the warning does not have to be a pop-up window, but is instead a visual effect, or an audio sound followed by the document reappearing unsent on the screen of the computing device.

Moreover, in one embodiment, the window 400 has two options, e.g., send 410 or cancel 420. Wherein send 410 disregards the warning and sends the document while cancel 420 cancels the sending of the document and provides the sender the opportunity to review the electronic document and attach the missing attachment before it is delivered. In another embodiment, the warning window will have fewer or more buttons and options.

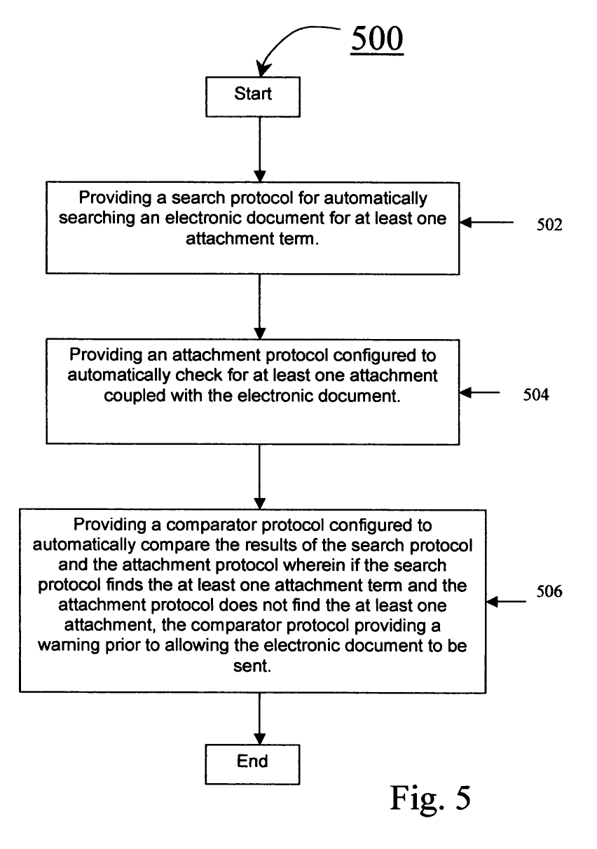

Referring now to FIG. 5, a flow chart of the steps for automatically checking an electronic document for at least one attachment prior to sending the electronic document is shown in accordance with one embodiment of the present invention.

With reference now to Step 502 of FIG. 5, one embodiment provides a search protocol for automatically searching an electronic document for at least one attachment term. With reference to FIG. 1, one attachment term 135 is shown within the body 130 of the document 100. In another embodiment, e.g., FIG. 2, the attachment term 135 may be located in the subject line 120 of the electronic document 200. In general, the at least one attachment term 135 may be a term such as attached, attaching, attach, aft, included, inc, enclosed, enc, encl, herewith, inserted, insert, and the like. In one embodiment, the terms to be searched for are user modifiable. That is, a user may provide additional attachment terms 135 to be searched for, or the user may remove one or more of the attachment terms 135 from the search list. Moreover, the attachment term 135 may be searched for in a plurality of languages.

In one embodiment, the attachment term 135 search occurs during the spell check operation. In another embodiment, the attachment term 135 search is independent of the spell check operation. In one embodiment, the automatic activation of the search protocol is initiated when the send 150 option is selected. In yet another embodiment, the automatic activation of the search protocol occurs as a background process.

With reference now to step 504 of FIG. 5, one embodiment provides an attachment protocol configured to automatically check for at least one attachment coupled with the electronic document. With reference to FIG. 1, one attachment 145 is shown within the attachment portion 140 of the document 100. In another embodiment, as shown in FIG. 2, the attachment 145 may be located within the body 130 of document 200. In yet another embodiment, the attachment may be found in the subject line 120 of the electronic document 200.

In general, the at least one attachment 145 may be a document, picture, presentation, audio file, video file, link or the like. In one embodiment, the activation of the attachment protocol is initiated when the send 150 option is selected. In another embodiment, the activation of the attachment protocol is initiated when the search protocol recognizes an attachment term (e.g., attachment term 135 of FIG. 1). In other words, when the search protocol recognizes an attachment term 135, the search protocol will signal the attachment protocol to search for an attachment 145. In yet another embodiment, the attachment protocol is initiated first, and if an attachment 145 is found/recognized, the search protocol is not activated.

Referring now to step 506 of FIG. 5, one embodiment provides a comparator protocol configured to automatically compare the results of the search protocol and the attachment protocol, wherein if the search protocol finds the at least one attachment term 135 and the attachment protocol does not find the at least one attachment 145, the comparator protocol provides a warning prior to sending the electronic document.

For example, with reference still to step 506 and now to FIGS. 1 and 2, in one embodiment, when activated (e.g., when send 150 is selected, or another initiation protocol such as spell check is activated), the search protocol automatically searches the electronic document 100 and finds the attachment term 135 (e.g., in the body 130 of FIG. 1, or the subject line of FIG. 2). The attachment protocol will also search the electronic document 100 for at least one attachment (e.g., attachment 145 in either attachment portion 140 of FIG. 1, or body portion 130 of FIG. 2).

As stated herein, in one embodiment, the attachment protocol initiates simultaneously with the search protocol. In another embodiment, the attachment protocol will initiate when the search protocol discovers the attachment term 135. In yet another embodiment, the attachment protocol initiates prior to the search protocol. The comparator protocol will then compare the results of the search protocol, e.g., an attachment term 135 was found, with the results of the attachment protocol, e.g., an attachment 145 was found. Therefore, the comparator protocol will not interfere with the delivery of the message in cases of both electronic documents 1 and 2.

Referring still to step 506 and now to FIG. 3, in one embodiment, when activated (e.g., when send 150 is selected, or another initiation protocol such as spell check), the search protocol automatically searches the electronic document 100 and finds the attachment term 135 (e.g., enclosed 135 in the body 130 of FIG. 3). The attachment protocol will also search the electronic document 100 for at least one attachment. As stated herein, in one embodiment, the attachment protocol initiates simultaneously with the search protocol. In another embodiment, the attachment protocol will initiate when the search protocol discovers the attachment term 135. In yet another embodiment, the attachment protocol initiates prior to the search protocol.

The comparator protocol will then compare the results of the search protocol, e.g., an attachment term 135 was found, with the results of the attachment protocol, e.g., an attachment 145 was not found. Therefore, the comparator protocol will provide a warning prior to allowing the electronic document 300 to be sent. That is, a warning such as warning box 400 of FIG. 4 will be initiated. The warning will provide the sender the opportunity to reevaluate the sending of the electronic document 300. For example, if the user were sending an electronic document 300 such as a response to a job offer and meant to include a resume, the present invention will stop the delivery of the document 300 that does not include a resume therein. In so doing, the receiving party will not receive the document 300 having no attachment, instead, the sender will have the opportunity to fix the error by attaching the missing resume. Thus, the receiving party is none the wiser to the averted dilemma.

In another embodiment, the attachment may be a photo to friend or family, a work related document, or the like. That is, the automatic attachment detector is equally useful in professional and non-professional applications. By reducing the possibility of a sender forgetting to attach anything to a document, the embarrassment to the sender is reduced as well as the need to resend a follow on electronic document, thereby reducing network traffic, inbox overload to a user, as well as a plurality of other inconvenient, annoying, embarrassing, and attention to detail type consequences.

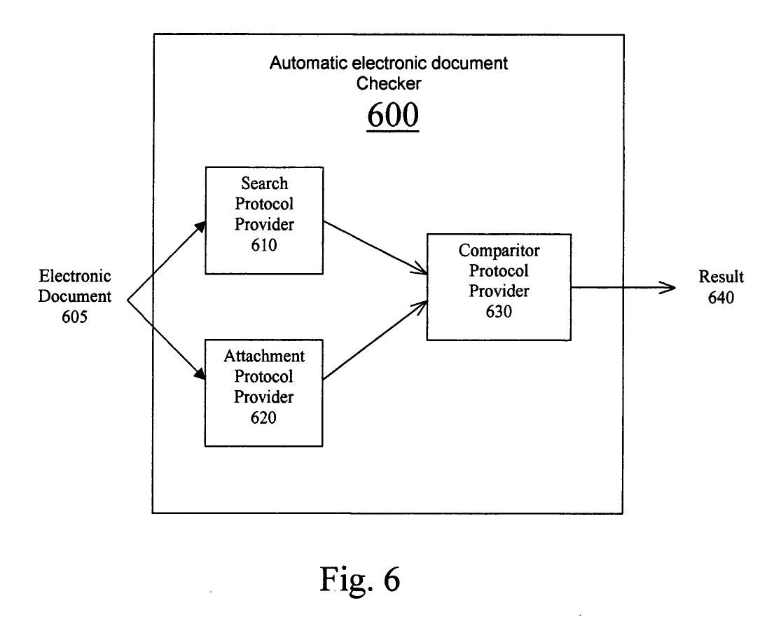

With reference now to FIG. 6, an automatic electronic document checker 600 is shown. In one embodiment, the electronic document checker 600 includes a search protocol provider 610, an attachment protocol provider 620 and a comparator protocol provider 630. As described in detail herein, the search protocol provider 610 automatically searches an electronic document 605 for at least one attachment term. The attachment protocol provider 620 automatically checks for at least one attachment coupled with the electronic document 605. The comparator protocol provider 630 automatically compares the results of the search protocol provider 610 and the attachment protocol provider 620. In so doing, if the search protocol provider 610 finds at least one attachment term and the attachment protocol provider 620 does not find at least one attachment, the comparator protocol provider 630 provides a warning (e.g., result 640) prior to allowing the electronic document 605 to be sent.

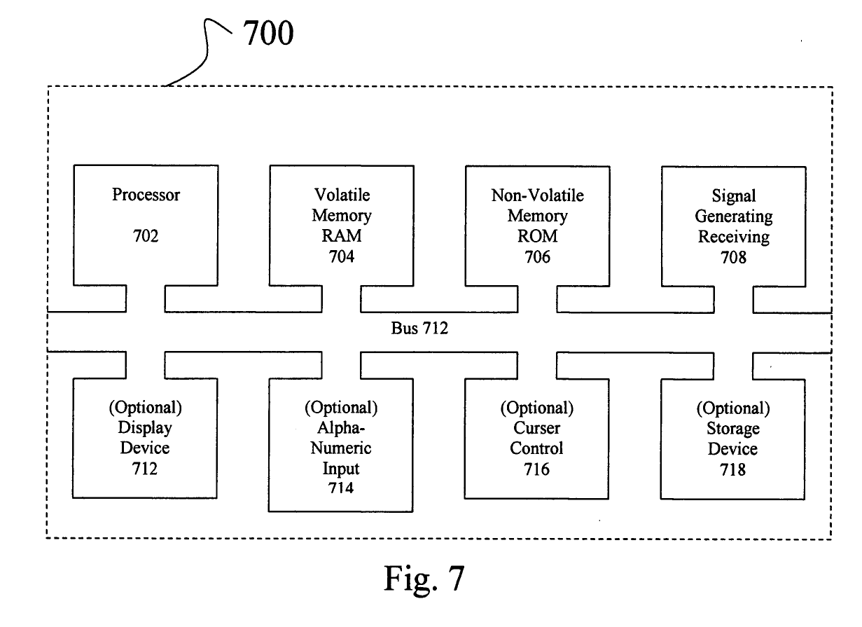

With reference now to FIG. 7, a block diagram of an embodiment of an exemplary computer system 700 used in accordance with the present invention. For example, computer system 700 may represent the computing system upon which the electronic document (100, 200 and/or 300) is written, is sent from or is received to. It should be appreciated that computing system 700 is not strictly limited to be a computer system. As such, computing system 700 of the present embodiment is well suited to be any type of computing device (e.g., server computer, portable computing device, desktop computer, mobile phone, pager, personal digital assistant, etc.). Within the following discussions of the present invention, certain processes and steps are discussed that are realized, in one embodiment, as a series of instructions (e.g., software program) that reside within computer readable memory units of computer system 600 and executed by a processor(s) of computing system 700. When executed, the instructions cause computer system 700 to perform specific actions and exhibit specific behavior that is described in detail herein.

Computer system 700 of FIG. 7 comprises an address/data bus 710 for communicating information, one or more central processors 702 coupled with bus 710 for processing information and instructions. Central processor unit(s) 702 may be a microprocessor or any other type of processor. The computer system 700 also includes data storage features such as a computer usable volatile memory unit 704 (e.g., random access memory, static RAM, dynamic RAM, etc.) coupled with bus 710 for storing information and instructions for central processor(s) 702, a computer usable non-volatile memory unit 706 (e.g., read only memory, programmable ROM, flash memory, EPROM, EEPROM, etc.) coupled with bus 710 for storing static information and instructions for processor(s) 702. Computer system 700 also includes one or more signal generating and receiving devices 708 coupled with bus 710 for enabling computer system 700 to interface with other electronic devices and computer systems. The communication interface(s) 708 of the present embodiment may include wired and/or wireless communication technology.

Optionally, computer system 700 may include an alphanumeric input device 714 including alphanumeric and function keys coupled to the bus 710 for communicating information and command selections to the central processor(s) 702. The computer system 700 can include an optional cursor control or cursor directing device 716 coupled to the bus 710 for communicating user input information and command selections to the central processor(s) 702. The cursor-directing device 716 may be implemented using a number of well-known devices such as a mouse, a track-ball, a track-pad, an optical tracking device, and a touch screen, among others. Alternatively, it is appreciated that a cursor may be directed and/or activated via input from the alphanumeric input device 714 using special keys and key sequence commands. The present embodiment is also well suited to directing a cursor by other means such as, for example, voice commands.

The computing system 700 of FIG. 7 may also include one or more optional computer usable data storage devices 718 such as a magnetic or optical disk and disk drive (e.g., hard drive or floppy diskette) coupled with bus 710 for storing information and instructions. An optional display device 712 is coupled to bus 710 of computing system 700 for displaying video and/or graphics. It should be appreciated that optional display device 712 may be a cathode ray tube (CRT), flat panel liquid crystal display (LCD), field emission display (FED), plasma display or any other display device suitable for displaying video and/or graphic images and alphanumeric characters recognizable to a user.

Thus, embodiments of the present invention provide methods and systems for automatically checking an electronic document for at least one attachment prior to sending the electronic document. Moreover, embodiments reduce the possibility of a sender forgetting to provide an attachment with a document. Embodiments further reduce the embarrassment to the sender as well as the need to resend a follow on electronic document, thereby reducing network traffic, inbox overload to a user, as well as a plurality of other inconvenient, annoying, embarrassing, and attention to detail type consequences.

Embodiments of the present invention are thus described. While the present invention has been described in particular embodiments, it should be appreciated that the present invention should not be construed as limited by such embodiments, but rather construed according to the following claims.

What is claimed is:

1. A method for automatically checking an electronic document for at least one attachment comprising:
providing a search protocol for automatically searching an electronic document for at least one attachment term;
providing an attachment protocol configured to automatically check for at least one attachment coupled with said electronic document; and
providing a comparator protocol configured to automatically compare the results of said search protocol and said attachment protocol wherein if said search protocol finds said at least one attachment term and said attachment protocol does not find said at least one attachment, said comparator protocol providing a warning prior to allowing said electronic document to be sent.

2. The method of claim 1 wherein said search protocol, said attachment protocol and said comparator protocol are initiated when said electronic document is selected to be sent.

3. The method of claim 1 wherein said search protocol further comprises:
searching the subject line of said electronic document for at least one attachment term.

4. The method of claim 1 wherein said at least one attachment term is selected from the list of terms consisting of: attached, attaching, attach, att, included, inc, enclosed, enc, encl, herewith, inserted, and insert.

5. The method of claim 1 wherein said warning consisting of:
providing a pop-up window with a missing attachment warning therein.

6. The method of claim 1 wherein said at least one attachment is selected from the list consisting of: at least one attachment coupled with the document and at least one attachment within the electronic document.

7. The method of claim 1 wherein said attachment protocol is initiated after said search protocol finds at least one attachment term.

8. A computer system comprising:
a bus;
a memory unit coupled to said bus; and
a processor coupled to said bus, said processor for executing a method for automatically checking an electronic document for at least one attachment comprising:
providing a search protocol for automatically searching an electronic document for at least one attachment term;
providing an attachment protocol configured to automatically check for at least one attachment coupled with said electronic document; and
providing a comparator protocol configured to automatically compare the results of said search protocol and said attachment protocol wherein if said search protocol finds said at least one attachment term and said attachment protocol does not find said at least one attachment, said comparator protocol providing a warning prior to allowing said electronic document to be sent.

9. The computer system of claim 8 wherein said search protocol, said attachment protocol and said comparator protocol are initiated when said electronic document is selected to be sent.

10. The computer system of claim 8 wherein said search protocol further comprises:
searching the subject line of said electronic document for at least one attachment term.

11. The computer system of claim 8 wherein said at least one attachment term is selected from the list of terms consisting of: attached, attaching, attach, att, included, inc, enclosed, enc, encl, herewith, inserted, and insert.

12. The computer system of claim 8 wherein said warning consisting of:
providing a pop-up window with a missing attachment warning therein.

13. The computer system of claim 8 wherein said at least one attachment is selected from the list consisting of:
at least one attachment coupled with the document and at least one attachment within the electronic document.

14. The computer system of claim 8 wherein said attachment protocol is initiated after said search protocol finds at least one attachment term.

15. A computer-usable medium having computer-readable program code embodied therein for causing a computer system to perform a method for automatically checking an electronic document for at least one attachment comprising:
providing a search protocol for automatically searching an electronic document for at least one attachment term;
providing an attachment protocol configured to automatically check for at least one attachment coupled with said electronic document when said search protocol finds said at least one attachment term; and
providing a comparator protocol configured to automatically compare the results of said search protocol and said attachment protocol wherein if said search protocol finds said at least one attachment term and said attachment protocol does not find said at least one attachment, said comparator protocol providing a warning prior to allowing said electronic document to be sent.

16. The computer-usable of claim 15 wherein said search protocol, said attachment protocol and said comparator protocol are initiated when said electronic document is selected to be sent.

17. The computer-usable of claim 15 wherein said search protocol further comprises:
searching the subject line of said electronic document for at least one attachment term.

18. The computer-usable of claim 15 wherein said at least one attachment term is selected from the list of terms consisting of: attached, attaching, attach, att, included, inc, enclosed, enc, encl, herewith, inserted, and insert.

19. The computer-usable of claim 15 wherein said warning consisting of:
providing a popup window with a missing attachment warning therein.

20. The computer-usable of claim 15 wherein said at least one attachment is selected from the list consisting of: at least one attachment coupled with the document and at least one attachment within the electronic document.
